(19) United States
(12) Patent Application Publication
(10) Pub. No.: US 2007/0061227 A1
(43) Pub. Date: Mar. 15, 2007

(54) Determining a computer system inventory

(75) Inventors: David J. Gimpl, Rochester, MN (US); Cale T. Rath, Byron, MN (US); George James Romano, Rochester, MN (US); Tammy Lynn Van Hove, Elgin, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/225,641

(22) Filed: Sep. 13, 2005

(51) Int. Cl. G06Q 10/00

(52) U.S. Cl. 705/28

(57) ABSTRACT

A method, apparatus, system, and signal-bearing medium that, in an embodiment, start a boot loader executing in a computer system, where the boot loader receives a load image from a server and stores the load image in volatile memory. The load image determines a detected inventory of the computer system via an I/O processor, and the boot loader and load image execute absent an operating system and without writing information to a non-volatile storage device. The load image sends the detected inventory to a network deposit location. A determination is made whether the detected inventory matches an expected inventory, and the difference between the detected inventory and an expected inventory is found. In this way, in an embodiment, the inventory of a computer may be determined without an operating system and without writing any information to non-volatile storage.

### FIELD

An embodiment of the invention generally relates to computers. In particular, an embodiment of the invention generally relates to determining an inventory of a computer system.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

As computer systems have become more powerful, they have also become more complex. Complex computer systems are difficult to correctly configure because many factors must be accounted for, such as bus placement, operating system driver relationships to the installed physical hardware, and the number and type of various I/O (Input/Output) devices, which may be accessed through IOPs (I/O Processors). Unfortunately, at the time that a computer system is configured for the first time, the operating system is typically not yet installed, which limits the ability of the computer hardware or firmware to detect an inventory of the installed hardware.

Without an installed and executing operating system, the firmware and hardware layers of a computer system can typically only detect the components that are attached to the primary computer bus segments, but cannot detect or interact with the devices on the other side of the IOPs. This limited view of the computer system's actual inventory hampers the planning, configuring, and deploying of computer systems because an operator must manually inspect, e.g., the computer system's storage device units (e.g., disk drives) to determine how much storage is present before starting the computer system's configuration steps. This manual inspection may require the operator to physically remove panels of the storage devices in order to inspect the disk units and the adapter slots in which they are plugged, which takes time and requires specialized training. This time and training increases the cost and slows down the configuration process.

Current techniques for addressing this problem rely on a installed operating system, which interacts with the IOPs in order to detect the installed inventory of the computer system. But, installing the operating system for the first time (a genesis install) requires knowing that the computer system has enough disk storage to hold the operating system, which again requires the operator to physically inspect the computer system.

What is needed is a better way to detect an inventory of the components of a computer system in which an operating system is not executing.

### SUMMARY

A method, apparatus, system, and signal-bearing medium are provided that, in an embodiment, start a boot loader executing in a computer system, where the boot loader receives a load image from a server and stores the load image in volatile memory. The load image determines a detected inventory of the computer system via an I/O processor, and the boot loader and load image execute absent an operating system and without writing information to a non-volatile storage device. The load image sends the detected inventory to a network deposit location. A determination is made whether the detected inventory matches an expected inventory, and the difference between the detected inventory and an expected inventory is found. In this way, in an embodiment, the inventory of a computer may be determined without an operating system and without writing any information to non-volatile storage.

### BRIEF DESCRIPTION OF THE DRAWING

Various embodiments of the present invention are hereinafter described in conjunction with the appended drawings:

FIG. 1 depicts a block diagram of an example system for implementing an embodiment of the invention.

FIG. 2 depicts a block diagram of an example server, according to an embodiment of the invention.

FIG. 3 depicts a block diagram of an example hardware management console, according to an embodiment of the invention.

FIG. 4 depicts a block diagram of an example inventory difference user interface, according to an embodiment of the invention.

FIG. 5 depicts a flowchart of example processing, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In an embodiment, a hardware management console copies a boot loader to the volatile memory of a computer system. In another embodiment, the boot loader exists in the computer system, e.g., in BIOS (Basic Input/Output System) or in an EEPROM (Electrically Erasable Programmable Read Only Memory). The boot loader requests a load image from a server, receives the load image from the server, stores the load image in the volatile memory, and starts the load image executing. The load image determines a detected inventory of the computer system via an 1/O processor, and the boot loader and load image execute absent or without an operating system and without writing information to a non-volatile storage device. The load image sends the detected inventory to a deposit location, from which the hardware management console retrieves the detected inventory. The hardware management console determines whether the detected inventory matches an expected inventory and determines the difference between the detected inventory and the expected inventory.

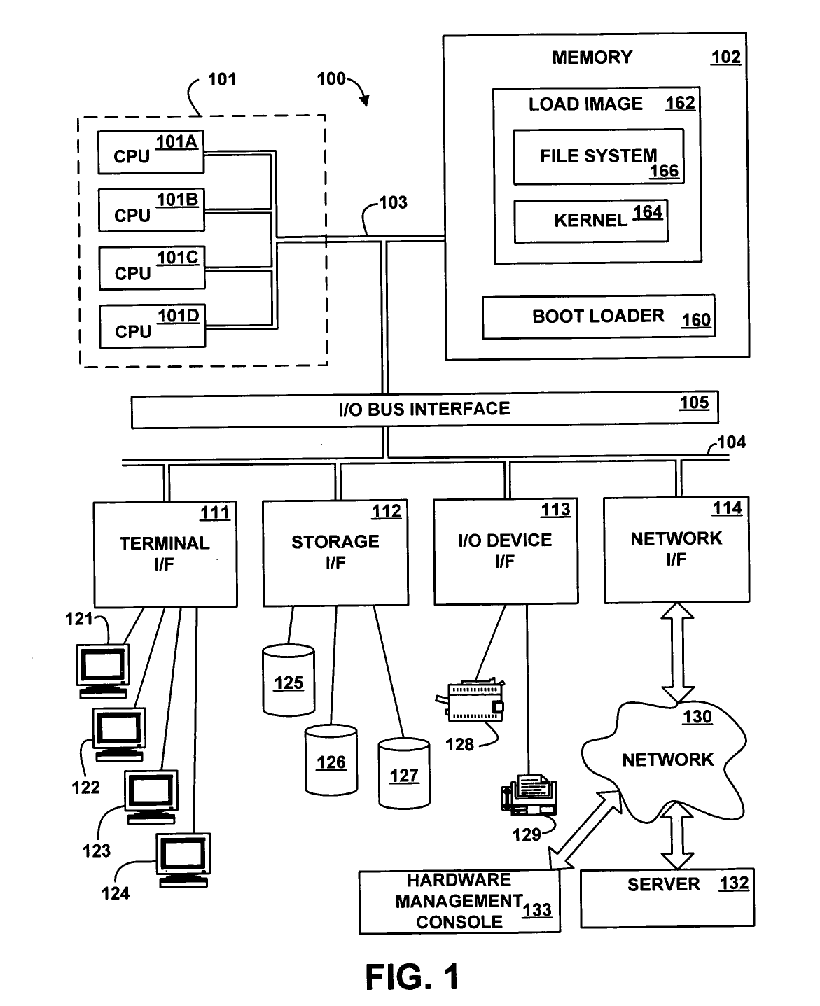

Referring to the Drawings, wherein like numbers denote like parts throughout the several views, FIG. 1 depicts a high-level block diagram representation of a client computer system 100 connected via a network 130 to a server 132 and a hardware management console 133, according to an embodiment of the present invention. The terms “computer system,” “client,” and “server” are used for convenience only, any appropriate electronic devices may be used, and in various embodiments a computer system or electronic device that operates as a client in one context may operate as a server in another context. The major components of the computer system 100 include one or more processors 101, a main volatile memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as a processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main volatile memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures. The main memory 102 is volatile in the sense that it does not retain its contents when power is interrupted.

The main volatile memory 102 includes a load image 162 and a boot loader 160. Although the load image 162 and the boot loader 160 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the load image 162 and the boot loader 160 are illustrated as being contained within the main memory 102, these elements are not necessarily all completely contained in the same physical storage device at the same time. Further, although the load image 162 and the boot loader 160 are illustrated as being separate entities, in other embodiments some of them, or portions of some of them, may be packaged together. In another embodiment, the boot loader 160 is part of the BIOS of the computer system 100 or exists in an EEPROM.

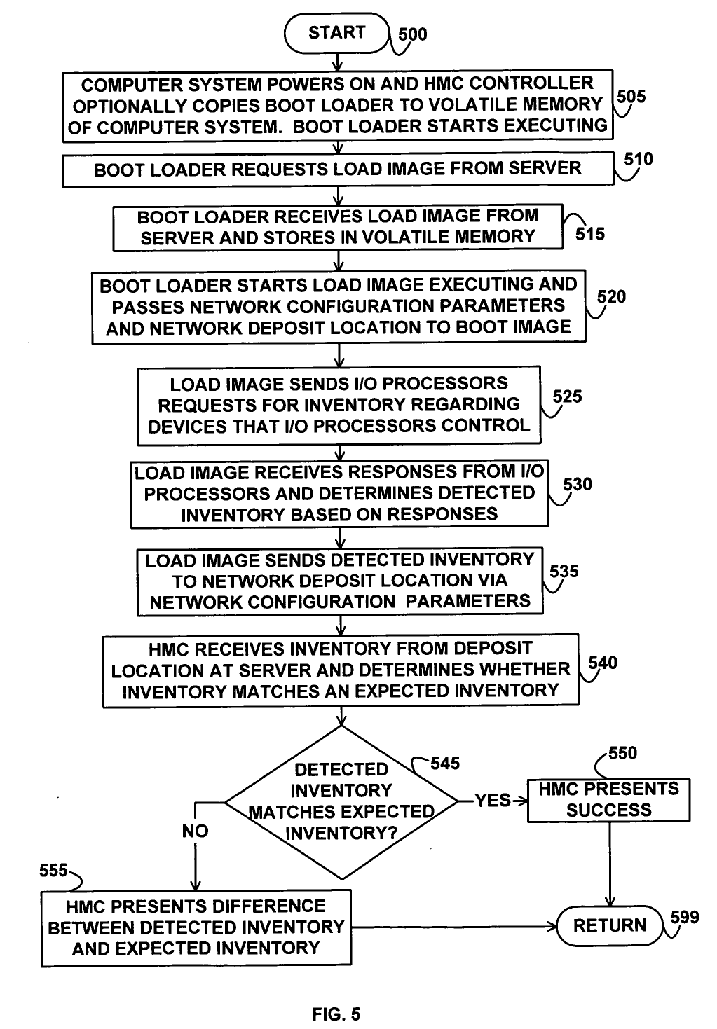

The load image 162 includes a bootable kernel 164 and a file system structure 166. In an embodiment, the load image 162 may be implemented via an enhanced Linux RAM (Random Access Memory) file system known as ramfs, but in other embodiments any appropriate load image that is capable of zero-presence operation may be used. The boot loader 160 loads the load image 162 into the memory 102 and then branches into the bootable kernel 164, which uses the file system structure 166 without accessing or writing any data to the non-volatile storage devices 125, 126, and 127 and without using any operating system functions. An operating system need not be executing or present at the computer system 100. The boot loader 160 also executes without writing any data to the non-volatile storage devices 125, 126, and 127 and without using any operating system functions. Thus, the boot loader 160 and the load image 162 do not need an operating system loaded or executing in the computer system 100 and do not leave any evidence of their presence behind after they finish executing. The load image 162 includes instructions capable of being executed on the processor 101 to perform the functions as further described below with reference to FIG. 5.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and 1/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The storage devices 125, 126, and 127 are nonvolatile in the sense that they retain their contents if power is interrupted.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100, the server 132, and/or the hardware management console 133. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3× specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an EEE 802.11B wireless network. In still another embodiment, the network 130 may be any suitable network or combination of networks. Although one network 130 is shown, in other embodiments any number of networks (of the same or different types) may be present.

Although the server 132 and the hardware management console 133 are illustrated as being connected to the computer system 100 via the network 130 and the network interface 114, in another embodiment, one or both of them may be connected to the computer system via a virtual network adapter without the benefit of the network interface 114 and/or the network 130. Although the server 132 and the hardware management console 133 are illustrated as being separate, in another embodiment they, or a portion thereof, may be packaged together.

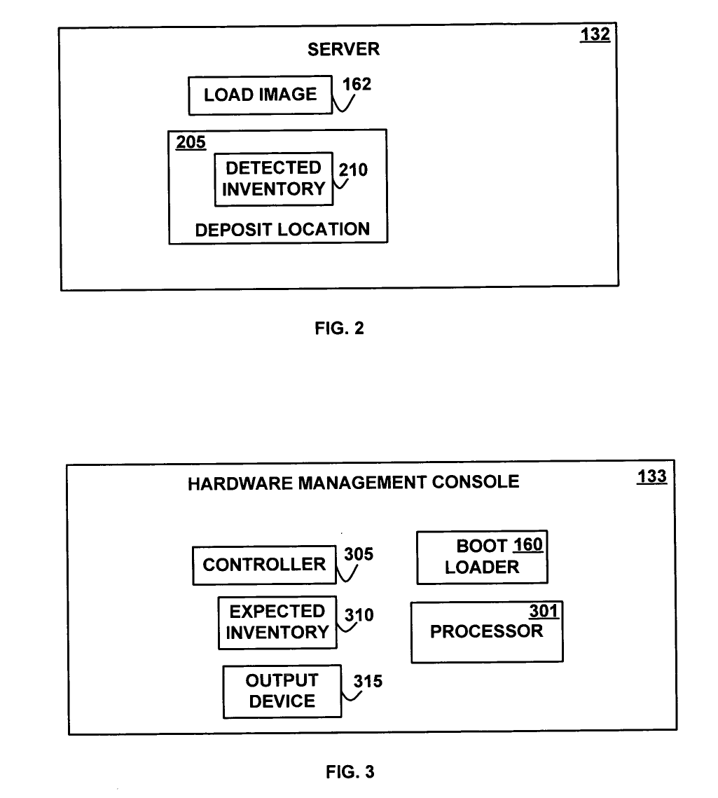

The server 132 sends the load image 162 to the computer system 100 and receives a detected inventory from the computer system 100. The server 132 may include any or all of the hardware and/or software components previously described above for the computer 100. The server 132 is further described below with reference to FIG. 2.

The hardware management console 133 copies the boot loader 160 to the computer system 100 (if the boot loader 160 does not already exist in the computer system 100) and compares an inventory that the load image 162 detects to an expected inventory. The hardware management console 133 may include any or all of the hardware and/or software components previously described above for the computer 100. The hardware management console 133 is further described below with reference to FIG. 3.

It should be understood that FIG. 1 is intended to depict the representative major components of the computer system 100, the server 132, and the hardware management console 133 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory devices in the computer system 100, the server 132, and/or the hardware management console 133, and that, when read and executed by one or more processors (e.g., the processor 101) in the computer system 100, the server 132, or the hardware management console 133, cause the computer system 100, the server 132, and the hardware management console 133 to perform the steps or elements comprising the various aspects of embodiments of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100, the server 132, and/or the hardware management console 133 via a variety of tangible signal-bearing media, which include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or (3) information conveyed by a transmissions or communications medium, such as through a computer or a telephone network, e.g., the network 130.

The tangible signal-bearing media may be operatively and communicatively connected, directly or indirectly, to a processor, such as the processor 101. Such tangible signal-bearing media, when carrying or encoding processor-readable, computer-readable, or machine-readable instructions or statements that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example server 132, according to an embodiment of the invention. The server 132 includes a load image 162 and a deposit location 205, which includes a detected inventory 210. The hardware management console 133 copies the load image 162 from the server 132 to the computer system 100. The load image 162 executes at the computer system 100, creates the detected inventory 210 of the computer system 100, and sends the detected inventory 210 to the server 132.

FIG. 3 depicts a block diagram of an example hardware management console 133, according to an embodiment of the invention. The hardware management console 133 includes the boot loader 160, a processor 301, a controller 305, an expected inventory 310, and an output device 315. The controller 305 includes instructions that execute on the processor 301 or includes statements that are interpreted by instructions that execute on the processor 301. In another embodiment, the controller 305 may be implemented in firmware or hardware. The controller 305 copies the boot loader 160 to the computer system 100 and compares the expected inventory 310 to the detected inventory 210, as further described below with reference to FIG. 5. The output device 315 may be a display terminal, analogous to the terminals 121, 122, 123, or 124, a speaker, a printer analogous to the printer 128, a fax machine analogous to the fax machine 129, or an other appropriate output device.

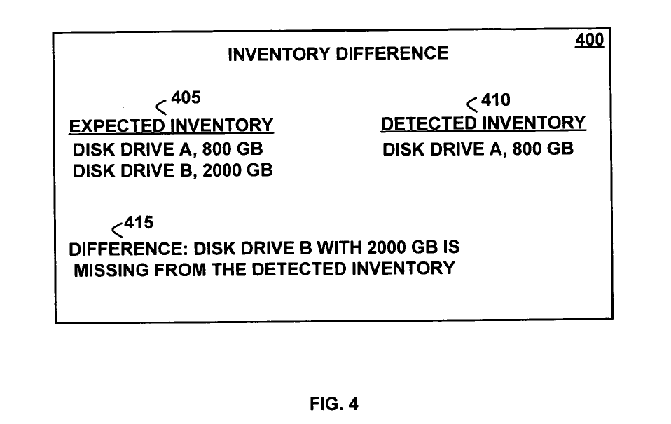

FIG. 4 depicts a block diagram of an example inventory difference user interface 400, according to an embodiment of the invention. The inventory difference user interface 400 includes example displays 405 and 410 of the expected inventory 310 and the detected inventory 210, respectively, as well as an explanation of the difference 415 between the expected inventory 310 and the detected inventory 210.

FIG. 5 depicts a flowchart of example processing, according to an embodiment of the invention. Control begins at block 500. Control then continues to block 505 where the computer system 100 powers on, the controller 305 optionally copies the boot loader 160 from the hardware management console 133 to the volatile memory 102 of the computer system 100, and the controller 305 starts the boot loader 160 executing on the processor 101 of the computer system 100 from the volatile memory 102. In another embodiment, the boot loader 160 is pre-existing in the computer system 100, e.g., in BIOS or an EEPROM, and starts executing in response to the computer system 100 powering on or in response to a signal or request from the controller 305. The computer system 100 may be powered on manually, or in response to request from the controller 305. The boot loader 160 executes without the benefit of any operating system and without writing any information to non-volatile storage, such as the storage devices 125, 126, or 127. Control then continues to block 510 where the boot loader 160 requests the load image 162 from the server 132.

Control then continues to block 515 where the server 132 sends the load image 162 to the computer system 100, and the boot loader 160 receives and stores the load image 162 in the volatile memory 102. Control then continues to block 520 where the boot loader 160 starts the load image 162 executing and passes network configuration parameters and the network deposit location 205 to the load image 162. The load image 162 executes absent any operating system and without writing any information to non-volatile storage, such as the storage devices 125, 126, or 127.

Control then continues to block 525 where load image 162 sends request(s) to the 1/O processors 111, 112, 113, and/or 114 for an inventory of the devices that the I/O processors control, e.g., an inventory of the terminals 121, 122, 123, and 124; the storage devices 125, 126, and 127, the printer 128 and the fax machine 120; and the network 130. In an embodiment, the inventory may include the number, type, identifiers, and capacity of the devices.

Control then continues to block 530 where the load image 162 receives responses from the I/O processors 111, 112, 113, and/or 114 and determines the detected inventory 210 based on the responses. Control then continues to block 535 where the load image 162 sends the detected inventory 210 to the network deposit location 205 via the network configuration parameters and the network 130. Control then continues to block 540 where the hardware management console 133 sends a request for the detected inventory 210 to the server 132 and receives the detected inventory 210 from the server 132. Control then continues to block 545 where the hardware management console 133 determines whether the detected inventory 210 matches the expected inventory 310.

If the determination at block 545 is true, then control continues to block 550 where the hardware management console 450 presents success. Control then continues to block 599 where the logic of FIG. 5 returns.

If the determination at block 545 is false, then control continues to block 555 where the hardware management console 133 determines the difference between the expected inventory 310 and the detected inventory 210 and presents the difference, e.g., via the output device 315 as previously described above with reference to FIG. 4. Control then continues to block 599 where the logic of FIG. 5 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
starting a boot loader executing in a computer system, wherein the boot loader receives a load image from a server and stores the load image in volatile memory, wherein the load image determines a detected inventory of the computer system, and wherein the boot loader and load image execute without writing information to a non-volatile storage device; and
determining whether the detected inventory matches an expected inventory.

2. The method of claim 1, wherein the boot loader and load image execute absent an operating system.

3. The method of claim 1, wherein the load image determines the detected inventory of the computer system via an I/O processor of the computer system.

4. The method of claim 1, further comprising:
presenting a difference between the detected inventory and the expected inventory.

5. The method of claim 1, wherein the boot loader passes a network deposit location to the load image and wherein the load image sends the detected inventory to the network deposit location.

6. The method of claim 5, further comprising:
retrieving the detected inventory from the network deposit location.

7. The method of claim 1, wherein the boot loader and load image execute on a processor of the computer system from the volatile memory of the computer system, and wherein the load image sends a request to the I/O processor that controls the non-volatile storage device without writing information to the non-volatile storage device.

8. A signal-bearing medium bearing instructions, wherein the instructions when executed comprise:
copying a boot loader to volatile memory of a computer system, wherein the boot loader receives a load image from a server and stores the load image in the volatile memory, wherein the load image determines a detected inventory of the computer system, wherein the boot loader and load image execute without writing information to a non-volatile storage device, and wherein the boot loader and load image execute absent an operating system; and
determining whether the detected inventory matches an expected inventory.

9. The signal-bearing medium of claim 8, wherein the load image determines the detected inventory of the computer system via an I/O processor of the computer system.

10. The signal-bearing medium of claim 8, further comprising:
presenting a difference between the detected inventory and the expected inventory.

11. The signal-bearing medium of claim 8, wherein the boot loader passes a network deposit location to the load image and wherein the load image sends the detected inventory to the network deposit location.

12. The signal-bearing medium of claim 11, further comprising:
retrieving the detected inventory from the network deposit location.

13. The signal-bearing medium of claim 8, wherein the boot loader and load image execute on a processor of the computer system from the volatile memory of the computer system, and wherein the load image sends a request to the I/O processor that controls the non-volatile storage device without writing information to the non-volatile storage device.

14. A computer system comprising a processor communicatively connected to the signal-bearing medium of claim 8.

15. A method for configuring a computer comprising:
configuring the computer to copy a boot loader to volatile memory of a computer system, wherein the boot loader receives a load image from a server and stores the load image in the volatile memory, wherein the load image determines a detected inventory of the computer system, wherein the boot loader and load image execute without writing information to a non-volatile storage device, and wherein the boot loader and load image execute absent an operating system; and
configuring the computer to determine whether the detected inventory matches an expected inventory.

16. The method of claim 15, wherein the load image determines the detected inventory of the computer system via an I/O processor of the computer system.

17. The method of claim 15, further comprising:
configuring the computer to present a difference between the detected inventory and the expected inventory.

18. The method of claim 15, wherein the boot loader passes a network deposit location to the load image and wherein the load image sends the detected inventory to the network deposit location.

19. The method of claim 18, further comprising:
configuring the computer to retrieve the detected inventory from the network deposit location.

20. The method of claim 15, wherein the boot loader and load image execute on a processor of the computer system from the volatile memory of the computer system, and wherein the load image sends a request to the I/O processor that controls the non-volatile storage device without writing information to the non-volatile storage device.
